(19) United States
(12) Patent Application Publication
(10) Pub. No.: US 2017/0203552 A1
(43) Pub. Date: Jul. 20, 2017

(54) Thermally Insulative Expanded Polytetrafluoroethylene Articles

(71) Applicant: W.L. Gore & Associates, Inc., Newark, DE (US)

(72) Inventors: Greg D. D'Arcy, West Chester, PA (US); James R. Hanrahan, Newark, DE (US); Steven R. Alberding, Middletown, DE (US); Joseph W. Henderson, Elkton, MD (US); Kevin J. Mabe, Elkton, MD (US); Anit Dutta, Wilmington, DE (US); Gregory D. Culler, Nottingham, PA (US)

(21) Appl. No.: 15/472,819

(22) Filed: Mar. 29, 2017

Related U.S. Application Data
(63) Continuation-in-part of application No. 14/576,439, filed on Dec. 19, 2014.
(60) Provisional application No. 61/918,246, filed on Dec. 19, 2013.

(51) Int. Cl. B32B 27/12; B32B 7/12; B32B 27/32; B32B 27/06; B32B 5/02

(52) U.S. Cl. CPC B32B 27/12; B32B 27/06; B32B 5/024; B32B 5/026; B32B 5/022; B32B 27/32; B32B 7/12; B32B 2307/304; B32B 2307/302; B32B 2307/3065

(57) ABSTRACT

Thermally insulative materials and articles are described. In one embodiment, the thermally insulative material comprises a polymer matrix, aerogel particles and expanded microspheres, wherein the aerogel particles are present in an amount of 30% by weight or greater, the polymer matrix is present in an amount of greater than or equal to 20% by weight and the expanded microspheres are present in an amount of 0.5% to 15% by weight, the percentages being based on the total weight of the polymer matrix, the aerogel particles and the expanded microspheres; and wherein the thermal conductivity of the thermally insulative material is less than 40 mW/m K at atmospheric conditions.

### FIELD

The present disclosure relates generally to thermally insulative materials and articles thereof, and more specifically to thermally insulative materials containing thermally insulative particles, such as aerogel particles, a polymer matrix and expandable microspheres.

### BACKGROUND

Use of aerogels for thermal insulation and the low thermal conductivity of aerogels is well known. Favorable thermally conductive properties result from the very high porosity of aerogel which is greater than about 95%, and the small pore size of aerogel material which is less than the size of the mean free path of air molecules at atmospheric pressure, or less than about 100 nm. Because of the small pore size, the mobility of air molecules within the material is restricted, and the effectiveness of air in conducting heat is reduced, resulting in low thermal conductivity. Under atmospheric conditions, air has a thermal conductivity of about 25 mW/m K (milliwatt per meter Kelvin). Insulation having larger pore sizes, such as foam, batting, wool, and other common thermally insulating materials, has a thermal conductivity of about 40 mW/m K, which is higher than that of air due to the contribution of radiation and solid conduction. Aerogel powders and beads are known to have a thermal conductivity of about 9 to 20 mW/m K. However, such highly porous and low density material is not useful for many applications in the form of a powder due to the extensive dusting which makes installation, handling, forming and shaping particularly difficult, and further raises safety issues.

Traditional methods of making aerogels usually include extraction with supercritical fluids. The methods often include the steps of pouring an aerogel precursor liquid into a mold, drying the aerogel liquid to form a highly porous gel structure with a variety of liquid exchanges, and using supercritical fluid extraction to form an aerogel monolith. Processes, such as those using supercritical fluid extraction, are very time consuming and expensive. Further, the structures produced are rigid and have low mechanical strength and have limited ability to be further molded or formed into desired shapes after the aerogel material is formed. These materials often crack or shatter upon flexing and are known for shedding or “dusting” of fine aerogel particles.

In an attempt to increase the flexibility and strength of aerogel material, Stepanian et al. U.S. Patent Publication 2002/0094426 teach aerogel materials combined with a reinforcing structure, specifically a lofty fibrous batting. Preferably, the aerogel is reinforced by a fibrous batting structure in combination with randomly oriented microfibers and/or conductive layers. To form the aerogel sheet, an aerogel-forming precursor liquid is poured into the batting and supercritically dried to form an aerogel. It is taught that the resulting reinforced aerogel structure is drapable, less prone to shattering upon flexing and less prone to shedding of fine aerogel particles. However, applications for such materials are limited due to a lack of moldability and formability of these structures, as well as the costs associated with supercritical extraction steps.

To overcome the brittleness often associated with reinforced aerogels, U.S. Pat. No. 5,786,059, to Frank et al. teaches gluing aerogel powders together to form a continuous product. Specifically, an aerogel composite material having a layer of fiber web and aerogel particles is preferably formed as a mat or panel. The fiber web comprises a bicomponent fiber material of two firmly interconnected polymers having lower and higher temperature melting regions into which aerogel particles are sprinkled. Upon heating to the lower melt temperature, the fibers of the web are bonded to each other as well as to the aerogel particles. The resulting composites are relatively stiff structures, and upon the application of mechanical stress, granules break or become detached from the fiber so that aerogel fragments may fall out from the web.

Smith et al., in U.S. Pat. No. 6,172,120, disclose a process for the manufacture of aerogels wherein aerogels are formed as powders instead of monolithic blocks or sheets. The manufacturing process has the advantage of aerogel formation without the step of supercritical fluid extraction. However, in the form of a powder, aerogel is not useful for many applications due to high dusting and lack of formability.

U.S. Pat. No. 7,118,801, to Ristic-Lehmann et al., teaches a material that is useful in multiple applications including insulation applications for garments, containers, pipes, electronic devices and the like. Among other things, the material of the '801 disclosure comprising aerogel particles and polytetrafluoroethylene (PTFE), is formable, having low particle shedding and low thermal conductivity. Composites made from the material may be flexed, stretched, and twisted, with little or no shedding of aerogel particles or loss of conductive properties.

There is a need for an insulating material that overcomes problems inherent in aerogel powders and composites, such as the lack of formability of aerogel powder and the lack of flexibility of composites, as well as the shedding or dusting of aerogel particles upon application of mechanical stress. There is a need for insulative material which may be formed into articles (e.g., expanded PTFE articles) that are hydrophobic, highly breathable, possess high strength, and which may be used in non-static, highly flexible applications. There is a further need for insulative articles which are flexible, stretchable, and bendable with little to no shedding or dusting of fine particles.

### SUMMARY

The present disclosure is directed, in one embodiment, to a thermally insulative material comprising an polymer matrix, aerogel particles and expanded microspheres; wherein the aerogel particles are present in an amount of 30% by weight or greater, the polymer matrix is present in an amount of greater than or equal to 20% by weight and the expanded microspheres are present in an amount of 0.5% to 15% by weight, wherein the percentages by weight are based on the total weight of the polymer matrix, the aerogel particles and the expanded microspheres; and wherein the thermal conductivity of the thermally insulative material is less than 40 mW/m K at atmospheric conditions.

In an alternative embodiment, the polymer matrix may comprise a fluoropolymer, a polytetrafluoroethylene, an expanded polytetrafluoroethylene, an ultrahigh molecular weight polyethylene (UHMWPE), an expanded ultrahigh molecular weight polyethylene, a polyolefin, an expanded polyolefin, a polyurethane or a combination thereof. In a further alternative embodiment, the thermally insulative material, when tested according to a 3-second exposure to a vertical flame, exhibits no melting, no dripping and/or no burnthrough.

In a further alternative embodiment, the thermally insulative material has a thermal conductivity of the matrix which is greater than 27 mW/m K and less than 39 mW/m K at atmospheric conditions. In a further alternative embodiment, the thermally insulative material is in the form of a sheet or a film, wherein the matrix further comprises one or more layers on the first side, the second side or both the first and the second side. In a further alternative embodiment, the one or more layers may comprise a polymer layer, a woven layer, a knit layer, a nonwoven layer or a combination thereof. In a further alternative embodiment, the one or more layers may comprise a fluoropolymer, a PTFE, a polyolefin, an expanded fluoropolymer, an expanded PTFE, an expanded polyolefin, a polyurethane or a combination thereof. In a further alternative embodiment, the one or more layers of the thermally insulative material may be adhered to the expanded polymer matrix using a continuous or discontinuous adhesive, and the adhesive optionally comprises a flame resistant material.

The present disclosure, in a further embodiment, provides for articles comprising the thermally insulative material described. Further, such articles may include in certain embodiments, but not be limited to, a glove insulation insert, a footwear insulation insert, a garment, a garment insert, pipe insulation, cryogenic insulation, an electronic device, cookware, a home appliance, a storage container, a food package, a pharmaceutical package, an immersion suit, an acoustic insulation, a thermal insulation and an electrical insulation.

The present disclosure, in a further embodiment, is directed to a thermally insulative material comprising an expanded PTFE (ePTFE) incorporating thermally insulative particles, said material having a thermal conductivity of less than or equal to 25 mW/m K at atmospheric conditions. In an alternative embodiment, the thermally insulative material exhibits an endotherm at about 380° C. In an alternative embodiment, the thermally insulative material is monolithic.

In an alternative embodiment, the thermally insulative material comprises an ePTFE having a tensile strength in the length direction of at least 0.35 MPa and a tensile strength in the transverse direction of at least 0.19 MPa.

In a further embodiment, the thermally insulative material may comprise less than 40% by weight thermally insulative particles and greater than 60% by weight polytetrafluoroethylene (ePTFE), wherein said composite material has a thermal conductivity of less than or equal to 25 mW/m K at atmospheric conditions.

In one or more embodiments where the thermally insulative material incorporates thermally insulative particles, the particles may be selected from silica aerogel particles, fumed silica, and combinations thereof.

In another embodiment, the thermally insulative material comprises expanded PTFE having a node and fibril structure and having a thermal conductivity of less than or equal to 25 mW/m K at atmospheric conditions. Further, the insulative material may comprise an expanded PTFE which exhibits about a 380° C. endotherm.

In another embodiment, the disclosure is directed to an article comprising a first layer, an expanded PTFE (ePTFE) having a thermal conductivity of less than or equal to 25 mW/m K at atmospheric conditions; and a second layer, wherein said ePTFE is sandwiched between said first and said second layers. In an alternative embodiment, the ePTFE is hydrophobic. Alternatively, at least one of said first and said second layer may be impermeable to gases. Further, at least one of said first and said second layer may be impermeable to liquids. In an alternative embodiment, the ePTFE comprises thermally insulative particles selected from silica aerogel and fumed silica.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a scanning electron micrograph of the surface of a thermally insulative material comprising an ePTFE material including 20% aerogel loading taken at 5000× magnification;

FIG. 2 is a scanning electron micrograph of the surface of a thermally insulative material comprising an ePTFE material including 40% aerogel loading taken at 5000× magnification;

FIG. 3 is a scanning electron micrograph of the surface of a thermally insulative material comprising an ePTFE material including fumed silica taken at 5000× magnification; and

FIG. 4 is scanning electron micrograph of the surface of a thermally insulative material comprising an ePTFE material including 60% aerogel loading taken at 5000× magnification.

### DETAILED DESCRIPTION

Persons skilled in the art will readily appreciate that various aspects of the present disclosure can be realized by any number of methods and apparatus configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

The insulative material of the present disclosure includes thermally insulative particles, such as aerogels and the like, and a polymer matrix. The polymer matrix can be, for example, a fluoropolymer, a polytetrafluoroethylene (PTFE), an ultrahigh molecular weight polyethylene (UHMWPE), a polyolefin, a polyurethane or a combination thereof. In some embodiments, the polymer matrix is a polytetrafluoroethylene, an expanded polytetrafluoroethylene or a combination thereof. The thermally insulative material may be formed into articles (e.g., ePTFE membranes, composites, etc.) that are hydrophobic, highly breathable, possess high strength, and which may be used in non-static, or dynamic flexing, applications. Articles produced from the thermally insulative materials are flexible, stretchable, and bendable. Also, the thermally insulative material has little to no shedding or dusting of fine particles. Aerogel particles having a particle density of less than about 100 kg/m³ and a thermal conductivity of less than or equal to about 15 mW/m K at atmospheric conditions (about 298.5 K and 101.3 kPa) may be used in the insulative material. It is to be understood that the term “aerogel(s)” and “aerogel particles” are used interchangeably herein.

Aerogels are thermal insulators which significantly reduce convection and conductive heat transfer. Silica aerogel particles are particularly good conductive insulators. Aerogel particles are solid, rigid, and dry materials, and may be commercially obtained in a powdered form. For example, a silica aerogel formed by a relatively low cost process is described by Smith et al. in U.S. Pat. No. 6,172,120. The size of the aerogel particles can be reduced to a desired dimension or grade by jet-milling or other size reduction techniques. Aerogel particles for use in the insulative material may have a size from about 1 μm to about 1 mm, from about 1 μm to about 500 μm, from about 1 μm to about 250 μm, from about 1 μm to about 200 μm, from about 1 μm to about 150 μm, from about 1 μm to about 100 μm, form about 1 μm to about 75 μm, from about 1 to about 50 μm, from about 1 μm to about 25 μm, from about 1 μm to about 10 μm, or from about 1 μm to about 5 μm. In at least one exemplary embodiment, the aerogel particles have a size from about 2 μm to about 24 μm.

Although not wishing to be bound by theory, it is believed that smaller aerogel particles form a more uniform mix with other components of the insulating material. Accordingly, aerogels having smaller particle sizes, for example, an average particle size of less than or equal to about 200 nm, or even 100 nm, may be used in the insulative material.

The density of the aerogel particle may be less than 100 kg/m³, less than 75 kg/m³, less than 50 kg/m, less than 25 kg/m³ or less than 10 kg/m³. In at least one exemplary embodiment, the aerogel particles have a bulk density from about 30 kg/m³ to about 50 kg/m³.

Aerogels suitable for use in the insulative material include both inorganic aerogels, organic aerogels, and mixtures thereof. Non-limiting examples of suitable inorganic aerogels include those formed from an inorganic oxide of silicon, aluminum, titanium, zirconium, hafnium, yttrium, and vanadium. Suitable organic aerogels for use in the insulative material include, but are not limited to, aerogels be prepared from carbon, polyacrylates, polystyrene, polyacrylonitriles, polyurethanes, polyimides, polyfurfural alcohol, phenol furfuryl alcohol, melamine formaldehydes, resorcinal formaldehydes, cresol, formaldehyde, polycyanurates, polyacrylamides, epoxides, agar, and agarose. In at least one exemplary embodiment, the insulative material contains an inorganic aerogel such as a silica. Another example of a thermally insulative particle suitable for the present disclosure is fumed silica.

Further, the aerogels used in the insulative material may be hydrophilic or hydrophobic. In exemplary embodiments, the aerogels are hydrophobic to partially hydrophobic and have a thermal conductivity of less than about 15 mW/m K. It is to be appreciated that particle size reduction techniques, such as milling, may affect some of the external surface groups of hydrophobic aerogel particles, which results in partial surface hydrophilicity (hydrophobic properties are retained within the aerogel particle). Partially hydrophobic aerogels may exhibit enhanced bonding to other compounds and may be utilized in applications where bonding is desired.

The thermally insulative material of the present disclosure further comprises a polymer matrix or an expanded polymer matrix, wherein the polymer matrix is a fluoropolymer, a polytetrafluoroethylene, an expanded polytetrafluoroethylene, an ultrahigh molecular weight polyethylene (UHMWPE), an expanded ultrahigh molecular weight polyethylene, a polyolefin, an expanded polyolefin, a polyurethane or a combination thereof. As used herein, an ultrahigh molecular weight means a polymer having a number average molecular weight in the range of from 3,000,000 to 10,000,000 g/mol. In some embodiments, the polymer matrix can be produced from polytetrafluoroethylene (PTFE) particles. In exemplary embodiments, the PTFE particles have a size smaller than the aerogel particles. However, it is to be understood that PTFE particles having a size similar to the aerogel particles may be used. Generally, the PTFE is present as primary particles that have a size of about 50 nm or greater or PTFE aggregates having a size of about 600 μm or less in a dispersion. The PTFE dispersion is an aqueous colloidal dispersion of high molecular weight PTFE particles formed by emulsion polymerization. The PTFE dispersion may have a SSG of about 2.2 or less.

The thermally insulative material is formed by preparing a mixture of aerogel and PTFE particles, such as, for example, by forming a mixture of an aqueous dispersion of aerogel particles and a PTFE dispersion. The aerogel/PTFE particle mixture may include, by weight, less than about 90% aerogel particles, less than about 85% aerogel particles, less than about 80% aerogel particles, less than about 75% aerogel particles, less than about 70% aerogel particles, less than about 65% aerogel particles, less than about 60% aerogel particles, less than about 55% aerogel particles, or less than about 50% aerogel particles. In some embodiments, the aerogel particles are present in the mixture in an amount less than 40%, less than or equal to 35%, less than or equal to 30%, less than or equal to 25%, less than or equal to 20%, less than or equal to 15%, or less than or equal to 10%. The aerogel particles may be present in the mixture an amount from about 10% to 40%. In exemplary embodiments, the aerogel particles may be present in an amount less than 40%.

Additionally, the aerogel/PTFE particle mixture may contain, by weight, greater than about 10% PTFE particles, greater than about 15% PTFE particles, greater than about 20% PTFE particles, greater than about 25% PTFE particles, greater than about 30% PTFE particles, greater than about 35% PTFE particles, greater than about 40% PTFE particles, greater than about 45% PTFE particles, or greater than about 50% PTFE particles. In exemplary embodiments, the PTFE particles are present in the mixture in an amount greater than or equal to 60%, greater than or equal to 65%, greater than or equal to 70%, greater than or equal to 75%, or greater than or equal to 80%. The PTFE particles may be present in an amount from about 60% to 90%. In exemplary embodiments, the PTFE particles may be present in the aerogel/PTFE particle mixture in an amount greater than 60%.

Properties such as thermal conductivity, dusting, formability and strength may be tailored in part by varying the ratio of the weight percentage of aerogel to PTFE in the mixture.

The thermally insulative material of the present disclosure may optionally comprise additional components. Optional components may be added to the aerogel/PTFE binder mixture such as finely dispersed opacifiers to reduce radiative heat transfer and improve thermal performance, and include, for example, carbon black, titanium dioxide, iron oxides, silicon carbide, molybdenum silicide, manganese oxide, polydialkylsiloxanes wherein the alkyl groups contain 1 to 4 carbon atoms, flame retardant materials or a combination thereof. Additionally, polymers, dies, plasticizers, thickeners, various synthetic and natural fibers, are optionally added, for example, to increase mechanical strength and to achieve properties such as color and thermal stability, elasticity and the like. Optional components are preferably added at less than about 10% of the aerogel/PTFE mixture.

In another embodiment, the thermally insulative material additionally include expandable microspheres such as Expancel, expandable microspheres. It is envisioned that other materials, expandable spheres, or foaming agents may be used to expand the thermally insulative material into a foamed material. The thermally insulative material containing expandable microspheres is co-coagulated and formed into a tape as described below. The tape may then be heated to a temperature sufficient to expand the microspheres, causing the tape to expand into a foamed insulating material. The amount of expandable microspheres and the processing temperature can affect the thickness of the final product. In some embodiments, a tape containing about 10 percent by weight of expandable microspheres and having a thickness of about 1 millimeter can be expanded to give a thermally insulative material having a thickness of up to about 8 millimeters or more. In other exemplary, non-limiting embodiments, for example, if the tape is 2 mm thick, heating and expansion may result in a foamed thermally insulative material that is 4 mm thick. The foamed thermally insulative material is pliable and compressible with substantially full recovery. In addition, the foamed thermally insulative material has a low density, for example, a density of less than 0.5 g/cm³, or less than 0.4 g/cm³, or less than 0.3 g/cm³ or less than 0.2 g/cm³, or less than 0.1 g/cm³.

In some embodiments, the thermally insulative material comprises a polymer matrix, aerogel particles and expanded microspheres. In other embodiments, the thermally insulative material may consist essentially of, or may consist of a polymer matrix, aerogel particles and expanded microspheres. The expandable microspheres can be present in an amount in the range of from about 0.5% to 15% by weight, based on the total weight of the aerogel particles, the PTFE particles and the expandable microspheres. In other embodiments, the expandable microspheres can be present at greater than about 0.5% by weight and up to 14, 13, 12, 11, 10, 9, 8, 7, 6, 5, 4, 3, 2 or 1% by weight. In still further embodiments, the expandable microspheres are present in the range of from about 5 to 14% or 6% to 13%, wherein all percentages by weight are based on the total amount of the polymer matrix, the aerogel particles and the expandable microspheres. As used herein, the phrase “consists essentially of” means that the thermally insulative material contains expanded polymer matrix, aerogel particles, expanded microspheres, optionally less than 10% by weight of the components listed as additional components and less than 2% by weight of any other component that would materially affect the properties described herein, for example, thermal conductivity.

The mixture of aerogel and PTFE particles in a carrier liquid, for example, water, a water insoluble alcohol or a combination thereof, may be co-coagulated, such as by coagulating the mixture by agitation or by the addition of coagulating agents. The co-coagulated mixture contains a substantially uniform blend of aerogel particles and PTFE particles. The co-coagulated mixture may be at least partially dried (e.g., in an oven) and compressed into a preform. The preform may then be extruded into a tape, calendered to a desired thickness, and expanded (uniaxially or biaxially) into a thermally insulative expanded PTFE (ePTFE) material. In other embodiments, a mixture of aerogel particles, the polymer matrix, for example, PTFE particles and expandable microspheres in the carrier liquid can be co-coagulated, by agitation or by the addition of coagulating agents. The co-coagulated mixture contains a substantially uniform blend of aerogel particles, polymer matrix particles and expandable microspheres. This mixture can be at least partially dried, for example, in an oven and compressed into a preform. The preform may then be extruded into a tape, calendered to a desired thickness and expanded (uniaxially or biaxially) into the thermally insulative material. The process of uniaxially or biaxially expanding the tape is typically preformed at elevated temperatures, for example, above the temperature at which the expandable microspheres expand. The expansion of the expandable microspheres can result in the formation of the expanded microsphere wherein less than complete expansion of the expandable microspheres, full expansion of the expandable microspheres, rupture of the expandable microspheres or a combination thereof.

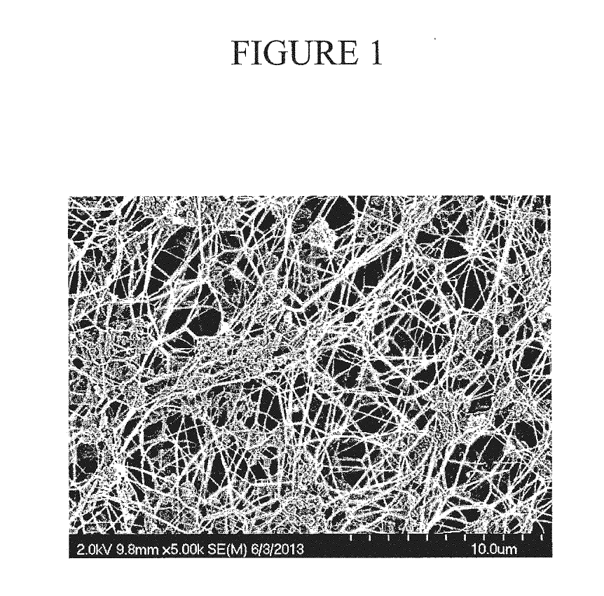

The resulting material is thermally insulative with a thermal conductivity (k) of less than or equal to 40, 39, 38, 37, 36, 35, 34, 33, 32, 31, 30, 29, 28, 27, 26, 25, 24, 23, 22 or 21 mW/m-K, less than or equal to 20 mW/m-K, or less than or equal to 15 mW/m-K, all at atmospheric conditions, that is, 298 K and 101.3 kPa. The ePTFE has a node and fibril structure as can be seen in FIGS. 1-4. Also, the ePTFE demonstrates high tensile strength in the length and transverse directions. Additionally, the ePTFE has high breathability, with an MVTR of at least 5,000 g/m²/24 hours, at least 10,000 g/m²/24 hours, at least 20,000 g/m²/24 hours, or at least 30,000 g/m²/24 hours or greater. As used herein, breathable is meant to describe an article with a breathability of at least 5,000 g/m²/24 hours.

It has been surprisingly found that a thermally insulative material comprising an expanded polymer matrix, aerogel particles and expanded microspheres wherein the aerogel particles are present in an amount of 30% by weight or greater, the expanded polymer matrix in an amount of greater than or equal to 20% by weight and the expandable microspheres in an amount of 0.5% to 15% by weight can produce a thermally insulative material that when tested according to a 3-second exposure to a vertical flame test (described below), exhibits no melting, no dripping and/or no burnthrough. The flammability test method is described below and is based on Federal Standard 191A Method 5903. In some embodiments, the thermally insulative material that is flame resistant comprises an expanded polytetrafluoroethylene matrix, aerogel particles and expanded microspheres, wherein the thermally insulative material is free from any an added flame retardant material. As used herein, flame resistant means that the thermally insulative material when tested according to the flammability test method below, resists melting, dripping, burnthrough or a combination thereof.

The thermally insulative material can optionally be laminated or adhered or otherwise bonded to one or more additional layers to form an article. For example, the thermally insulative material is typically in the form of a sheet or a film having a first side and a second side, wherein the thickness is less than the width and/or length directions. One or more layers can be adhered to the first side, to the second side or to both the first and the second side of the thermally insulative material. The one or more additional layers can be a polymer layer, a woven layer, a knit layer, a nonwoven layer or a combination thereof. The polymer layer can be a nonporous layer, a microporous layer, a breathable layer or a combination thereof. For example, the one or more layers may be a fluoropolymer, a PTFE, a polyolefin, an expanded fluoropolymer, an expanded PTFE, an expanded polyolefin, a polyurethane or a combination thereof. The one or more layers can be adhered to the thermally insulative material using an adhesive, welding, calendering, coating or a combination thereof. In some embodiments, the thermally insulative material can have an expanded polytetrafluoroethylene layer adhered to the first side, to the second side or to both the first side and the second side. In some embodiments, the article can comprise multiple layers, for example, the thermally insulative material can have a layer of expanded PTFE bonded to one or both sides, resulting in a composite material having a 2-layer or a 3-layer structure. One or more additional textile layers, for example, a woven, a knit, a non-woven or a combination thereof, may be adhered to the composite material. Typically, textile layers can be adhered using an adhesive material. The adhesive may be applied to the thermally insulative material, to the textile or to both in a continuous or a discontinuous manner, as is known in the art. In some embodiments, the adhesive may optionally comprise a flame resistant material.

The one or more textile layers can be a woven, a knit, a nonwoven or a combination thereof. In further embodiments, the woven, knit or nonwoven textiles can be flame resistant woven, flame resistant knit or flame resistant nonwoven textiles. Suitable textile layers are well known in the art and can include elastic and non-elastic textiles, for example, LYCRA®, polyurethane, polyester, polyamide, acrylic, cotton, wool, silk, linen, rayon, flax, jute; flame resistant textiles, for example, NOMEX® aramid (available from Du Pont, Wilmington, Del.), aramids, flame resistant cotton, polybenzimidazole, poly p-phenylene-2,6-bezobisoxazole, flame resistant rayon, modacrylics, modacrylic blend, polyamine, carbon, fiberglass or a combination thereof.

In one embodiment, the thermally insulative ePTFE material is used as insulation in a footwear article. The ePTFE material may be used in any portion of the footwear article, including the upper portion, heel portion, toe portion, or sole (bottom) portion. In addition to, or alternative to the thermally insulative ePTFE, the foamed thermally insulative material may be used as insulation in a footwear article. For instance, the foamed thermally insulative material may be utilized in the upper portion, heel portion, toe portion, and/or sole (bottom) portion. In at least one exemplary embodiment, an insulated footwear article includes at least one thermally insulative ePTFE material in the upper portion of the footwear article and a foamed thermally insulative material in the sole (bottom) portion of the footwear article. As used herein, the term “footwear article” is meant to include shoes and boots.

In addition to the above, formable, moldable, low dusting materials with low thermal conductivity are considered to be within the purview of the disclosure. These materials are sufficiently moldable to be formed into flexible three-dimensional structures or shapes having curves in one or more directions. Further, the materials optionally form stretchable structures with minimal dusting upon stretching. They may be wrapped around a tube or pipe for insulation.

The thermally insulative materials described herein may be used in numerous applications, including insulating materials and composites made therefrom for use in apparel, such as glove and footwear insulation inserts, garments, and inserts for garments, pipe insulation, cryogenic insulation, electronic devices, cookware, home appliances, storage containers and packaging of food and pharmaceuticals, immersion suits, as well as dual function insulation, such as acoustic insulation, electrical insulation, thermal insulation, and the like.

The disclosure of this application has been described above both generically and with regard to specific embodiments. It will be apparent to those skilled in the art that various modifications and variations of the disclosure can be made without departing from the spirit or scope of the disclosure, as defined in the appended claims.

### Test Methods

It should be understood that although certain methods and equipment are described below, any method or equipment determined suitable by one of ordinary skill in the art may be alternatively utilized.

### Moisture Vapor Transmission Rate Test—(MVTR)

The MVTR for each sample fabric was determined in accordance with the general teachings of ISO 15496 except that the sample water vapor transmission (WVP) was converted into MVTR moisture vapor transmission rate (MVTR) based on the apparatus water vapor transmission (VWPapp) and using the following conversion.

MVTR=(Delta P value*24)/((1 WVP)+(1+WVPapp value))

To ensure comparable results, the specimens were conditioned at 73.4±0.4° F. and 50±2% relative humidity (rH) for 2 hrs prior to testing and the bath water was a constant 73.4° F.±0.4° F.

The MVTR for each sample was measured once, and the results are reported as g/m²/24 hours.

Tensile Strength

Tensile Strength of the membrane was measured using an INSTRON® 5565 tensile test machine equipped with flat-faced grips and a 0.445 kN load cell. The gauge length was 6.35 cm and the cross-head speed was 50.8 cm/min (strain rate=13.3%/sec). To ensure comparable results, the laboratory temperature was maintained between 68° F. (20° C.) and 72° F. (22.2° C.) to ensure comparable results. Data was discarded if the sample broke at the grip interface.

For longitudinal (length direction) tensile strength measurements, the larger dimension of the sample was oriented in the machine, or “down web,” direction. For the transverse tensile strength measurements, the larger dimension of the sample was oriented perpendicular to the machine direction, also known as the “cross web” direction. The thickness of the samples was then measured using a Mitutoyo 547-400 Absolute snap gauge. The samples were then tested individually on the tensile tester. Three different sections of each sample were measured. The average of the three maximum load (i.e., the peak force) measurements was used.

The longitudinal and transverse tensile strengths were calculated using the following equation:

Tensile strength=maximum load/cross-section area

The average of three cross-web measurements was recorded as the longitudinal and transverse tensile strengths.

### Thickness

Sample thickness was measured with the integrated thickness measurement of the thermal conductivity instrument. (Laser Comp Model Fox 314 Laser Comp Saugus, Mass.). The results of a single measurement was recorded.

### Thermal Conductivity Measurement (Under Compression)

Thermal conductivity of samples of the present disclosure was measured using a custom-made heat flow meter thermal conductivity tester following the general teachings of ASTM C518 plus the addition of compression at atmospheric conditions (about 298 K and 101.3 kPa). The tester consisted of a heated aluminum plate with a heat flow sensor (Model FR-025-TH44033, Concept Engineering, Old Saybrook, Conn.) and a temperature sensor (thermistor) imbedded in its surface, and a second aluminum plate maintained at room temperature, also with a temperature sensor imbedded in its surface.

The temperature of the heated plate was maintained at 303.15 K while the temperature of the “cold” plate was kept at 298.15 K. The diameter of the plates was about 10 cm. The sample was compressed by applying weights to a pivoting arm connected to the lower plate. The thickness of the samples under compression was measured by a digital encoder which was calibrated with metal shims which were measured using a digital micrometer (model ID-F125E, Mitutoyo Corp., Japan). The heat flow measurement was normally obtained within about two to five minutes after the sample was placed in the tester upon reaching a steady state. Thermal conductivity was calculated from the measured heat flow and the thickness of the sample according to the formula: k=L*Q, where k is thermal conductivity in mW/m K, L is sample thickness in m, Q is heat flow in mW/m² K. The results of a single measurement was recorded.

Thermal Conductivity (without Compression)

Thermal conductivity was also measured without compressing the sample. The samples were measured with a Laser Comp Model Fox 314 thermal conductivity analyzer. (Laser Comp Saugus, Mass.). The results of a single measurement was recorded.

### Air Flow Measurements (ATEQ)

The airflow measurements were made with an ATEQ model D520 (ATEQ Livonia, Mich.) the instrument was fitted with a round seal having a flow area of 2.99 cm². The average of two measurements was recorded.

### Gurley Number

The resistance of samples to air flow was measured by a Gurley densometer (Model 4340 manufactured by Gurley Precision Instruments Troy, N.Y. The results are reported in terms of Gurley number which is the time in seconds for 100 cubic centimeters of air to pass through 1 square inch of a test sample at a pressure drop of 4.88 inches of water. The results of a single measurement was recorded.

### Water Entry Pressure (WEP)

Water entry pressure provides a test method for water intrusion through membranes and/or fabrics. A test sample is clamped between a pair of testing plates taking care not to cause damage. The lower plate has the ability to pressurize a section of the sample with water. A piece of paper towel is placed on top of the sample between the plate on the non-pressurized side as an indicator of evidence for water entry. The sample is then pressurized in small increments until the first visible sign of water through the paper towel indicates breakthrough pressure or entry pressure. The pressure was recorded as the water entry pressure. The results of a single measurement was recorded.

### Flammability Test Method

Samples of the thermally insulative material having a size of about 75 millimeter (mm) by 200 mm were conditioned at 21° C. and 50%±2% relative humidity for 2 hours prior to testing. The conditioned samples were placed in sealed sample bags after conditioning until they were removed for testing.

All testing was carried out in a laboratory hood and a flame cabinet as described in Fed Std 191A Method 5903. A movable Fisher burner supplied with butane through a supply valve, regulator, needle valve and flexible hose arrangement as specified in NFPA 1971-34, 2000 Edition (capable of supplying a consistent gas flow of 17.3 kpa+−1.7 kpa) was used as the flame source. A steel sample holder centered the bottom of the sample approximately 38 mm above the top of the Fisher burner. The aforementioned burner and sample holder were located inside of the flame cabinet.

The sample was placed horizontally on the sample holder and held in place using medium size binder clips. The laboratory hood airflow was set to low. The burner was positioned away from the sample holder in the flame cabinet. The needle valve was closed and the supply valve opened. The needle valve was opened and the burner lit. The flame height was adjusted to 75 mm. The burner was allowed to burn for 1 minute and flame height readjusted, if necessary. The burner was then moved under the specimen, placing the flame as close to the center of the sample as possible, and a timer started for 3 seconds. At the end of 3 seconds, the burner was moved out from under the specimen. If the sample does not burn or goes out immediately upon removal of the flame, the timer was stopped. If the sample burns, the timer was allowed to continue until the flame extinguished. In order to determine the afterflame time, 3 seconds was subtracted from the timer measured time and the result recorded. Any melting, dripping, or hole formation was also recorded. Hole formation either through ablation or burning is known as burn through and was also recorded. Melting, Dripping or burn-through constituted the test sample to fail the test.

### EXAMPLES

### Example 1

A dispersion form of PTFE 601 (commercially available from E. I. DuPont de Nemours, Inc., Wilmington, Del.) and Aerogel (Enova Aerogel MT 1200, Cabot, Boston, Mass.) was obtained. The PTFE and Aerogel were co-coagulated in the following manner. 91 grams of Hexanol (PN H13303-4L, Sigma-Aldrich, St Louis, Mo.) was added to 14.4 Kg of water and mixed for 1 minute in a Silverson Model EX60 mixer (Silverson Machines Inc, East Longmeadow, Mass.) at an impeller speed of 1500 rpm. Mixing continued until the aerogel was fully wet-out (approximately 6-10 minutes). 3.46 Kg of PTFE dispersion was then added and the mixer speed was increased to 1500 rpm for 1.5 minute. The resulting coagulum was dewatered through a Reemay sheet (item#2014-686, Reemay, Old Hickory Tenn.) and then dried for 24 hours at 165° C. in a forced air oven.

The resulting dry coagulum was then blended with ISOPAR K (1 kg/kg) (Exxon Mobile Chemical, Houston Tex.) and subsequently compressed into a cylindrical preform. The preform was then extruded through a barrel to provide a wet tape 15.2 cm wide and 3.7 mm thick.

The wet tape was calendered to a thickness of 2.2 mm and dried in a forced air oven set to 150° C. for 4 minutes and then at 250° C. for an additional 4 minutes.

The dried, calendered tape was then biaxially expanded simultaneously in both directions in the following manner: expansion ratio of 8:1, in the length direction and 18:1 in the transverse direction at a rate of 500%/sec at 250° C.

The resulting thermally insulating ePTFE membrane had the following properties: tensile strength in the length and transverse directions: 1.54 MPa and 1.53 MPa, respectively; thickness: 0.36 mm; thermal conductivity without compression: 21 mW/m-K; thermal conductivity at 5 psi compression: 8.9 mW/m-K; MVTR (MDM): 32508 g/m²/24 hours: Gurley Number 0.7 sec; ATEQ airflow: 6.2 1/hr-cm² at 4.5 mBar pressure drop; and Water Entry Pressure (WEP): 29 psi. A 5,000 magnification scanning electron micrograph (SEM) of the surface is shown in FIG. 1. The nodes (10) and fibrils (20) are indicated.

### Example 2

A thermally insulating ePTFE membrane was made as follows. A dispersion form of PTFE 601 (commercially available from E. I. DuPont de Nemours, Inc., Wilmington, Del.) and Aerogel (Enova Aerogel MT 1200, Cabot, Boston, Mass.) were obtained. The PTFE and Aerogel were co-coagulated in the following manner. 136 grams of Hexanol was added to 15.1 Kg of water and mixed for 1 minute with an impeller speed of 1500 rpm. The speed was slowed to 500 rpm and 363 grams of silica aerogel was slowly added. Mixing continued until the aerogel was fully wet-out (approximately 6-10 minutes). 2.59 Kg of PTFE dispersion was then added and the mixer speed was increased to 1500 rpm for 1.5 minutes. The resulting coagulum was dewatered through a Reemay sheet and then dried for 24 hours at 165° C. in a hot air oven.

The resulting dry coagulum was then blended with ISOPAR K at a ratio of 1.5 kg/kg and subsequently compressed into a cylindrical perform. The preform was then extruded through a barrel to provide a wet tape 15.2 cm wide and 3.7 mm thick.

The wet tape was calendered to a thickness of 2.2 mm and dried in a forced air oven set to 150° C. for 4 minutes and then 250° C. for an additional 4 minutes.

The dried, calendered tape was then biaxially expanded in both directions simultaneously in the following manner: expansion ratio of 3:1, in the longitudinal direction and 6:1 in the transverse direction at a rate of 500%/sec at 250° C.

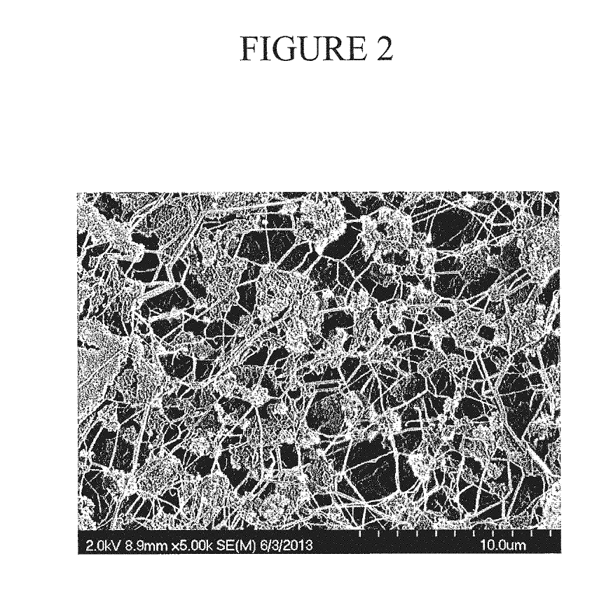

The resulting thermally insulating ePTFE membrane had the following properties: tensile strength in the length and transverse directions, respectively: 0.59 MPa and 0.7 MPa, respectively; thickness: 0.86 mm; thermal conductivity without compression: 21 mW/m-K; thermal conductivity at 5 psi compression: 10 mW/m-K; MVTR (MDM): 9798 g/m²/24 hours; Gurley Number 1.4 sec; ATEQ airflow: 2.71/hr-cm² at 4.5 mBar pressure drop; and Water Entry Pressure (WEP): 34 psi. A 5000 magnification scanning electron micrograph (SEM) of the surface is shown in FIG. 2. The nodes (10) and fibrils (20) are indicated.

### Example 3

Another thermally insulating ePTFE membrane was made as follows. A dispersion form of PTFE 601 (commercially available from E. I. DuPont de Nemours, Inc., Wilmington, Del.) and fumed silica (Aerosil R812, Evonik Industries AG, Hanau Germany) were obtained. The PTFE and fumed silica were co-coagulated in the following manner. 280 grams of Hexanol were added to 23 Kg of water and mixed for 1 minute at an impeller rate of 1500 rpm. The impeller rate was decreased to 500 rpm and 750 grams of fumed silica was slowly added. Mixing continued for 15 minutes. 4.4 Kg of PTFE dispersion was then added and the mixer speed was increased to 1500 rpm for 3.33 minutes. The resulting coagulum was dewatered using a Reemay sheet and then dried for 24 hours at 165° C. in a hot air oven.

The resulting dry coagulum was then blended with 95 wt % ISOPAR K and 5% lauric acid (PN L556, Sigma Aldrich, St Louis, Mo.) at 1.1 kg/kg and subsequently compressed into a cylindrical perform. The preform was then extruded through a barrel to provide a wet tape 15.2 cm wide and 3.4 mm thick.

The wet tape was calendered to a thickness of 2 mm and dried in a forced air oven set to 250° C.

The dried, calendered tape was then biaxially expanded simultaneously in both directions in the following manner: expansion ratio in both directions=6:1, expansion rate in both directions=500%/sec rate, 280° C.

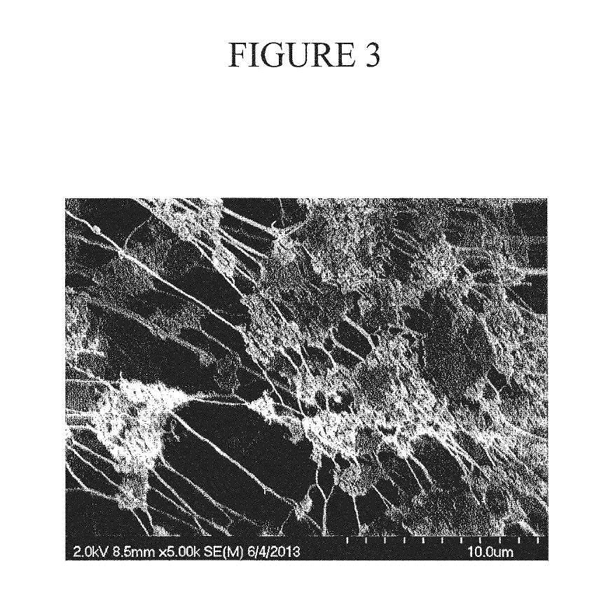

The resulting thermally insulating ePTFE membrane had the following properties: tensile strength in the length and transverse directions: 0.35 MPa; and 0.19 MPa, respectively; thickness: 0.86 mm; thermal conductivity without compression: 23 mW/m-K; and thermal conductivity at 5 psi compression: 16 mW/m-K. A 5,000× magnification scanning electron micrograph (SEM) of the surface is shown in FIG. 3. The nodes (10) and fibrils (20) are indicated.

### Example 4

A dispersion form of PTFE 601 (commercially available from E.I. DuPont de Nemours, Inc., Wilmington, Del.) and Aerogel (Enova Aerogel MT 1200, Cabot, Boston, Mass.) were obtained. The PTFE and Aerogel were co-coagulated in the following manner. 181 grams of Hexanol was added to 15.7 Kg of water and mixed for 1 minute with an impeller speed of 1500 rpm. The impeller speed was decreased to 500 rpm and 544 grams of silica aerogel was slowly added. Mixing continued until the aerogel was fully wet-out (approximately 6-10 minutes). 1.73 Kg of PTFE dispersion was then added and the mixer speed was increased to 1500 rpm for 1.5 minute. The resulting coagulum was dewatered through a Reemay sheet (item#2014-686, Reemay, Old Hickory Tenn.) and then dried for 24 hours at 165° C. in a forced air oven.

The resulting dry coagulum was then blended with ISOPAR K (1.5 kg/kg) and subsequently compressed into a cylindrical preform. The preform was then extruded through a barrel to provide a wet tape 15.2 cm wide and 3.7 mm thick.

The wet tape was calendered to a thickness of 2.2 mm and dried in a forced air oven set to 150° C. for 4 minutes and then 250° C. for an additional 4 minutes.

The dried, calendered tape was then biaxially expanded simultaneously in both directions in the following manner: expansion ratio of 4:1, in the length direction and 6:1 in the transverse direction at a rate of 500%/sec at 250° C.

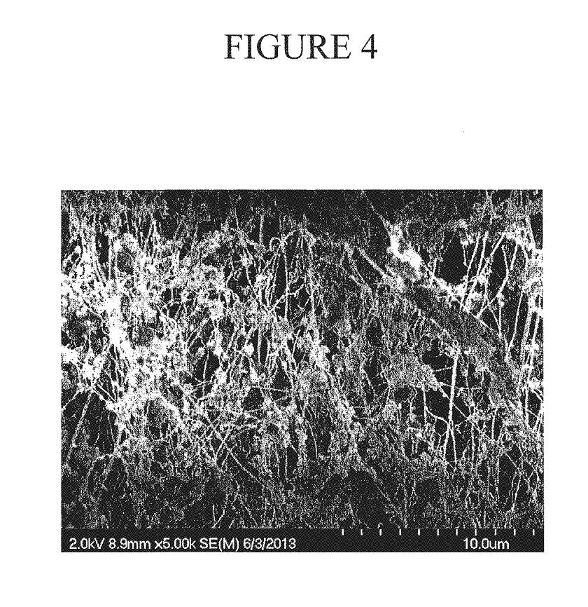

The resulting thermally insulating ePTFE membrane had the following properties: tensile strength in the length and transverse directions: 0.7 MPa and 0.27 MPa, respectively; thickness: 1.1 mm; thermal conductivity without compression: 22 mW/m K; thermal conductivity at 5 psi compression: 12.2 mW/m K; Gurley Number: 0.7 sec; ATEQ airflow: 5.21/hr-cm² at 4.5 mBar pressure drop; and Water Entry Pressure (WEP): 28 psi. A 5,000× magnification scanning electron micrograph (SEM) of the surface is shown in FIG. 4. The nodes (10) and fibrils (20) are indicated.

### Comparative Example A

A comparative thermally insulative material was produced using PVOH as the polymer matrix. 50 grams (g) of unexpanded Expancel 951 DU 120 manufactured by Akzo Nobel, NV, Amsterdam, Netherlands was combined with 50 g of ENOVA® MT1200 aerogel particles manufactured by Cabot Corporation, Boston, Mass. in a 4 liter plastic tub. In a separate container, 250 milliliters (ml) (41.5% solids) of Elmer's Glue All, a PVOH based adhesive was mixed by stirring with 400 ml of water in a separate container. The PVOH and water admixture was then poured into the plastic tub containing the aerogel and Expancel particles. The tub was sealed and mixed by tumbling until it reached the consistency of stiff whipped cream.

A PTFE release material was then placed on a table and dusted lightly with ENOVA® MT1200 aerogel particles to prevent sticking and a golf ball sized aliquot of the aerogel/Expancel/PVOH mixture was placed on the release material and rolled into a disc approximately 3 mm thick and 150 mm in diameter using a 90 mm diameter cardboard tube wrapped with PTFE release material. This disk forming process was repeated on a second sample and the resulting discs along with the release material were placed in a 150° C. oven for approximately 30 minutes (min), initiating Expancel expansion, then moved to a 100° C. oven and allowed to completely dry overnight. The resulting material had a thickness of 6.58 mm.

### Example 5

A thermally insulative material was made as follows. A dispersion of PTFE 601 (commercially available from E. I. DuPont de Nemours, Inc., Wilmington, Del.) and Aerogel (ENOVA® MT 1200 aerogel, Cabot, Boston, Mass.) were co-coagulated in the following manner. 308 g of hexanol was added to 23.9 kilograms (kg) of water and mixed for 1 minute with an impeller speed of 1500 rpm. The speed was slowed to 500 rpm and 817 g of the ENOVA® aerogel particles were slowly added. The mixing was continued until the aerogel particles were fully wet-out (approximately 6-10 minutes). 2.17 kg of PTFE dispersion and 136 g of Expancel 951 DU 120 was then added and the mixer speed was increased to 1500 rpm for 1.5 minutes. The resulting coagulum was dewatered through a Reemay sheet and then dried for 24 hours at 125° C. in a hot air oven.

The resulting dry coagulum was then blended with ISOPAR K at a ratio of 1.04 kg/kg and subsequently compressed into a cylindrical perform. The preform was then extruded through a barrel to provide a wet tape 15.2 cm wide and 3.7 mm thick. The wet tape was calendered to a thickness of 0.78 mm and dried in a forced air oven set to a temperature of 150° C. for 4 minutes and then 190° C. for an additional 4 minutes. The final drying step caused the Expancel to expand. This enlargement caused the dried, calendered tape to biaxially expanded in both directions simultaneously. The thermally insulative material had a thickness of 2.25 mm, a thermal conductivity without compression of XX mW/mK; an MVTR of 3086 g/m²/24 hours.

### Example 6

A dispersion of PTFE 601 (commercially available from E. I. DuPont de Nemours, Inc., Wilmington, Del.) and aerogel (ENOVA® MT 1200 aerogel, Cabot, Boston, Mass.) was co-coagulated in the following manner. 308 grams of hexanol was added to 23.9 kg of water and mixed for 1 minute with an impeller speed of 1500 rpm. The speed was slowed to 500 rpm and 817 grams of the ENOVA® aerogel was slowly added. The mixing was continued until the aerogel was fully wet-out (approximately 6-10 minutes). 2.17 kg of PTFE dispersion and 13.6 grams of Expancel 951 DU 120 was then added and the mixer speed was increased to 1500 rpm for 1.5 minutes. The resulting coagulum was dewatered through a Reemay sheet and then dried for 24 hours at 125° C. in a hot air oven.

The resulting dry coagulum was then blended with ISOPAR K at a ratio of 1.04 kg/kg and subsequently compressed into a cylindrical perform. The preform was then extruded through a barrel to provide a wet tape 15.2 cm wide and 3.7 mm thick. The wet tape was calendered to a thickness of 0.78 mm and dried in a forced air oven set to 150° C. for 4 minutes and then 190° C. for an additional 4 minutes. The final drying step caused the Expancel to expand. This enlargement caused the dried, calendered tape to biaxially expanded in both directions simultaneously. The thermally insulative material had a thickness of 1.25 mm, a thermal conductivity without compression of XX mW/mK: an MVTR of 4475 g/m²/24 hours.

### Comparative Example B

A dispersion of PTFE 601 (commercially available from E. I. DuPont de Nemours, Inc., Wilmington, Del.) and Aerogel (Enova Aerogel MT 1200, Cabot, Boston, Mass.) was co-coagulated in the following manner. 308 grams of hexanol was added to 23.9 kg of water and mixed for 1 minute with an impeller speed of 1500 rpm. The speed was slowed to 500 rpm and 817 grams of ENOVA® aerogel was slowly added. The mixing was continued until the aerogel was fully wet-out (approximately 6-10 minutes). 2.17 kg of PTFE dispersion and 272 grams of Expancel 951 DU 120 was then added and the mixer speed was increased to 1500 rpm for 1.5 minutes. The resulting coagulum was dewatered through a Reemay sheet and then dried for 24 hours at 125° C. in a hot air oven.

The resulting dry coagulum was then blended with ISOPAR K at a ratio of 1.04 kg/kg and subsequently compressed into a cylindrical perform. The preform was then extruded through a barrel to provide a wet tape 15.2 cm wide and 3.7 mm thick. The wet tape was calendered to a thickness of 0.78 mm and dried in a forced air oven set to 150° C. for 4 minutes and then 190° C. for an additional 4 minutes. The final drying step caused the Expancel to expand. This enlargement caused the dried, calendered tape to biaxially expanded in both directions simultaneously. The thermally insulative material had the following properties; thickness: 3.37 mm; thermal conductivity without compression: xx mW/m-K; MVTR (MDM): 3271 g/m²/24 hours.

### Comparative Example C

A dispersion of PTFE 601 (commercially available from E. I. DuPont de Nemours, Inc., Wilmington, Del.) and Expancel 951 DU 120 expanding hollow particles, Akzo Nobel, Amsterdam, Nebr.)) was co-coagulated in the following manner. 308 grams of hexanol was added to 23.9 kg of water and mixed for 1 minute with an impeller speed of 1500 rpm. The speed was slowed to 500 rpm and 54 grams of Expancel was slowly added. The mixing was continued until the expanding hollow particles were fully wet-out (approximately 6-10 minutes). 2.17 of PTFE dispersion was then added and the mixer speed was increased to 1500 rpm for 1.5 minutes. The resulting coagulum was dewatered through a Reemay sheet and then dried for 24 hours at 125° C. in a hot air oven.

The resulting dry coagulum was then blended with ISOPAR K at a ratio of 1.04 kg/kg and subsequently compressed into a cylindrical perform. The preform was then extruded through a barrel to provide a wet tape 15.2 cm wide and 3.7 mm thick. The wet tape was calendered to a thickness of 0.78 mm and dried in a forced air oven set to 150° C. for 4 minutes and then 190° C. for an additional 4 minutes. The final drying step caused the expancel to expand. This enlargement caused the dried, calendered tape to biaxially expanded in both directions simultaneously. The resulting thermally insulative material had the following properties; thickness: 1.1 mm; thermal conductivity without compression: xx mW/m-K; MVTR (MDM): 1990 g/m²/24 hours.

Examples 5, 6, 7 and Comparative Examples A, B and C were tested using the Flammability Test described above. The results of this test are found in TABLE 1.

| | | | Comparative | Comparative | Comparative |
|---|---|---|---|---|---|
| | Example 5 | Example 6 | Example A | Example B | Example C |
| Weight ratio polymer | 30/60/10 | 39.6/59.4/1 | 51/24.5/24.5 | 33.3/50/16.7 | 90/0/10 |
| matrix/aerogel/expandable | | | | | |
| microspheres | | | | | |
| Thermal Conductivity | 26.35 | 23.33 | Too brittle | 26.56 | 31.37 |
| (uncompressed) | | | to measure | | |
| Total Burn time | 6.97 | 5.00 | 253.88 | 73.68 | 4.00 |
| (seconds) | | | | | |
| Afterflame (seconds) | 3.97 | 2.00 | 250.88 | 70.68 | 1.00 |
| Melt (Yes = 1, No = 0) | 0 | 0 | 0 | 0 | 0 |
| Drip (Yes = 1, No = 0) | 0 | 0 | 1 | 1 | 1 |
| Burnthrough (Yes = 1, | 0 | 0 | 1 | 1 | 1 |
| No = 0) | | | | | |
| Pass/Fail | Pass | Pass | Fail | Fail | Fail |

The examples of Table 1 show that the disclosed thermally insulative materials provide excellent thermal conductivity and excellent flame resistance.

The disclosure of this application has been described above both generically and with regard to specific embodiments. Although the disclosure has been set forth in what is believed to be the preferred embodiments, a wide variety of alternatives known to those of skill in the art can be selected within the generic disclosure. The disclosure is not otherwise limited, except for the recitation of the claims set forth below.

1. A thermally insulative material comprising an polymer matrix, aerogel particles and expanded microspheres; wherein the aerogel particles are present in an amount of 30% by weight or greater, the polymer matrix is present in an amount of greater than or equal to 20% by weight and the expanded microspheres are present in an amount of 0.5% to 15% by weight, wherein the percentages by weight are based on the total weight of the polymer matrix, the aerogel particles and the expanded microspheres; and wherein the thermal conductivity of the thermally insulative material is less than 40 mW/m K at atmospheric conditions.

2. The thermally insulative material of claim 1 wherein the polymer matrix is a fluoropolymer, a polytetrafluoroethylene, an expanded polytetrafluoroethylene, an ultrahigh molecular weight polyethylene (UHMWPE), an expanded ultrahigh molecular weight polyethylene, a polyolefin, an expanded polyolefin, a polyurethane or a combination thereof.

3. The thermally insulative material of claim 1 or 2 wherein the polymer matrix is expanded polytetrafluoroethylene and the expanded polytetrafluoroethylene exhibits an endotherm at about 380° C.

4. The thermally insulative material of any one of claims 1 to 3, when tested according to a 3-second exposure to a vertical flame, exhibits no melting, no dripping and/or no burnthrough.

5. The thermally insulative material of any one of claims 1 to 4 wherein the thermal conductivity of the matrix is greater than 27 mW/m K and less than 39 mW/m K at atmospheric conditions.

6. The thermally insulative material of any one of claims 1 to 5 in the form of a sheet or a film, wherein the matrix further comprises one or more layers on the first side, the second side or both the first and the second side.

7. The thermally insulative material of claim 6 wherein the one or more layers is a polymer layer, a woven layer, a knit layer, a nonwoven layer or a combination thereof.

8. The thermally insulative material of claim 6 or 7 wherein the one or more layers is a fluoropolymer, a PTFE, a polyolefin, an expanded fluoropolymer, an expanded PTFE, an expanded polyolefin, a polyurethane or a combination thereof.

9. The thermally insulative material of any one of claims 6 to 8 wherein the one or more layers is adhered to the expanded polymer matrix using a continuous or discontinuous adhesive, and the adhesive optionally comprises a flame resistant material.

10. An article comprising the thermally insulative material of any one of claims 1 to 9.

11. The article of claim 10 wherein the article is a glove insulation insert, a footwear insulation insert, a garment, a garment insert, pipe insulation, cryogenic insulation, an electronic device, cookware, a home appliance, a storage container, a food package, a pharmaceutical package, an immersion suit, an acoustic insulation, a thermal insulation or an electrical insulation.
